(19) United States
(12) Patent Application Publication
(10) Pub. No.: US 2012/0113179 A1
(43) Pub. Date: May 10, 2012

(54) RECORDING APPARATUS

(75) Inventors: Koji Higuchi, Shiojiri-shi (JP); Keishi Sawada, Shiojiri-shi (JP)

(73) Assignee: SEIKO EPSON CORPORATION, Tokyo (JP)

(21) Appl. No.: 13/282,956

(22) Filed: Oct. 27, 2011

(30) Foreign Application Priority Data
Nov. 5, 2010 (JP) 2010-248839

(51) Int. Cl. B41J 29/38

(52) U.S. Cl. 347/16

(57) ABSTRACT

A recording apparatus includes: a support member in which a plurality of suction holes that apply suction to a recording medium are formed in a support surface that supports the recording medium; a transport device that transports the recording medium along the support surface; a recording head that prints onto the recording medium supported by the support surface by ejecting a fluid; and a regulating member, provided downstream from the suction holes formed in the location that is furthest downstream in the transport direction, that suppresses the recording medium from lifting off the support surface by more than a predetermined height.

### BACKGROUND

The entire disclosure of Japanese Patent Application No: 2010-248839, filed Nov. 5, 2010 is expressly incorporated by reference herein in its entirety.

1. Technical Field

The present invention relates to recording apparatuses.

2. Related Art

JP-A-2003-211749 discloses an ink jet printer that serves as a recording apparatus.

This ink jet printer uses roll paper as its recording medium, and, in a region where printing is carried out by an ink jet head, includes a plurality of suction holes in a platen in order to maintain the levelness of the roll paper, which may lift off due to the influence of curls caused by the winding. The plurality of suction holes become gradually smaller from the upstream side of the transport direction of the recording medium toward the downstream side, and also become gradually smaller from the vicinity of the central location in the width direction of the recording medium toward the outer sides in the width direction.

According to this configuration, as the recording medium is transported, the suction holes are blocked starting from the large suction holes, and thus an increase in the suction pressure can be accelerated. In other words, the flow resistance of the suction holes is high even if the small suction holes are not blocked and are instead in an open state, and it is accordingly possible to ensure a suction pressure sufficient to maintain the levelness of the recording medium.

However, the stated ink jet printer is configured so as to print onto the recording medium in a state in which the suction holes disposed downstream from the ink jet head printing region are open. If such is the case, the ink ejected from the ink jet head will be pulled toward the suction holes during flight, resulting in what is known as “curved flight” of the ink. There are accordingly cases where a drop in the print quality will result.

### SUMMARY

It is an advantage of some aspects of the invention to provide a recording apparatus capable of suppressing a drop in print quality while maintaining the levelness of a recording medium.

It is preferable that a recording apparatus according to an aspect of the invention include: a support member in which a plurality of suction holes that apply suction to a recording medium are formed in a support surface that supports the recording medium; a transport device that transports the recording medium along the support surface; a recording head that prints onto the recording medium supported by the support surface by ejecting a fluid; a control device that causes the recording head to execute the printing when the leading edge of the recording medium in the transport direction has reached a position where the leading edge covers the suction holes formed in the location of the support surface that is furthest downstream in the transport direction; and a regulating member, provided downstream from the suction holes formed in the location of the support surface that is furthest downstream in the transport direction, that suppresses the recording medium from lifting off the support surface by more than a predetermined height.

By employing such a configuration, in this invention, the recording medium is transported along the support surface of a platen, and when the leading edge of the recording medium in the transport direction has reached the position where the leading edge covers the suction holes formed in the location of the support surface that is furthest downstream in the transport direction, the printing is executed by the recording head. By doing so, all of the suction holes are blocked, and unnecessary airflow is not generated in the periphery of the recording medium, which makes it possible to suppress a drop in the print quality caused by the fluid experiencing curved flight. However, if printing is executed by the recording head at the point in time when the leading edge of the recording medium in the transport direction has reached the position where the leading edge covers the suction holes formed in the location of the support surface that is furthest downstream in the transport direction, the lift-off of the leading edge of the recording medium cannot be suppressed as the recording medium gradually moves away from the suction region due to the transport during printing; accordingly, the regulating member is provided downstream from the suction region, and suppresses the leading edge of the recording medium from lifting off. Accordingly, it is possible to suppress the leading edge of the recording medium that has moved away from the suction region from lifting off and coming into contact with the recording head, and possible to suppress the lift-off of the leading edge from affecting the lift off of the recording medium at the printing region as well, which opens some of the suction holes and pulls the fluid to the rear of the recording medium.

According to another aspect of the invention, it is preferable that a suction region in which the plurality of suction holes apply suction to the recording medium include, in the transport direction, a printing region in which printing is carried out by the recording head, and extends further upstream and further downstream than the printing region; and the length of the suction region on the downstream side in the transport direction is less than the length of the suction region on the upstream side.

By employing such a configuration, in this invention, the suction region that is downstream in the transport direction from the printing region is relatively smaller than the suction region that is upstream in the transport direction from the printing region, and therefore the area of the recording medium that extends outside of the printing region on the downstream side in the transport direction can be reduced. Accordingly, it is possible to secure a greater area of the recording medium on which printing is carried out.

According to another aspect of the invention, it is preferable that a contact portion of the regulating member that makes contact with the recording medium and suppresses the recording medium from lifting off be provided at a distance from the support surface, in the vertical direction relative to the support surface, that is greater than or equal to the thickness of the recording medium.

By employing such a configuration, in this invention, even if the leading edge of the recording medium lifts off, the contact portion is disposed at a distance from the support surface that is greater than or equal to the thickness of the recording medium; accordingly, the leading edge of the recording medium can be introduced into that space, and the lift-off can be suppressed.

According to another aspect of the invention, it is preferable that a contact portion of the regulating member that makes contact with the recording medium and suppresses the recording medium from lifting off be the circumferential surface of a roller supported so as to be freely-rotatable around a shaft extending in the width direction of the recording medium, the width direction being orthogonal to the transport direction.

By employing such a configuration, in this invention, the rollers can prevent the occurrence of abrasions and the like on the recording medium by converting friction generated with the recording medium into their own rotational movement.

According to another aspect of the invention, it is preferable that the recording medium extend and be transported from a roll member.

By employing such a configuration, in this invention, curls in the recording medium that extends and is transported from the roll member are corrected by the plurality of suction holes, which makes it possible to increase the levelness of the recording medium. In addition, the leading edge of the recording medium that has moved away from the suction region can be suppressed from lifting off by the regulating member.

According to another aspect of the invention, it is preferable that the location of the regulating member in the transport direction be set based on curling properties of the recording medium.

Because the amount by which the recording medium lifts off is dependent on the curling properties of the recording medium (that is, the strength of the curl, the material, the humidity, and so on), by employing such a configuration, the invention sets the position of the regulating member in the transport direction taking those curling properties into consideration.

According to another aspect of the invention, it is preferable that the recording apparatus further include a second support surface that opposes the regulating member and supports the recording medium, and the second support surface is provided further from the recording head, in the vertical direction relative to the support surface, than the support surface.

By employing such a configuration, in this invention, even if the leading edge of the recording medium lifts off, that lift-off can be pushed away from the recording head, which makes it possible to prevent the leading edge of the recording medium from coming into contact with the recording head.

According to another aspect of the invention, it is preferable that a suction region in which the plurality of suction holes apply suction to the recording medium extend in the width direction of the recording medium, the width direction being orthogonal to the transport direction; and the recording apparatus further include a suction stopping device that stops the suction applied by the suction hole in the areas of the suction region that are outside of the recording medium in the width direction.

By employing such a configuration, in this invention, the suction region extends in the width direction, and also corresponds to a plurality of sizes for the recording medium. Furthermore, the suction applied by the suction holes in regions outside of the recording medium is stopped, and thus unnecessary airflow is not generated in the periphery of the recording medium.

### BRIEF DESCRIPTION OF THE DRAWINGS

The invention will be described with reference to the accompanying drawings, wherein like numbers reference like elements.

FIG. 1 is a general block diagram illustrating an ink jet printer according to an embodiment of the invention.

FIG. 2 is a perspective view of a recording unit according to an embodiment of the invention.

FIG. 3 is a plan view illustrating a platen provided in a support platform according to an embodiment of the invention.

FIG. 4 is an exploded perspective view illustrating a support platform according to an embodiment of the invention.

FIG. 5 is an exploded perspective view illustrating a support platform according to an embodiment of the invention.

FIG. 6 is an exploded perspective view illustrating a main support platform unit according to an embodiment of the invention.

FIGS. 7A and 7B are perspective views of a cam mechanism in a suction stopping device according to an embodiment of the invention.

FIG. 8 is a diagram illustrating the layout of paper pressure rollers according to an embodiment of the invention.

FIG. 9 is a graph illustrating degrees to which the leading edge of paper lifts off from a support surface, according to an embodiment of the invention.

### DESCRIPTION OF EXEMPLARY EMBODIMENTS

An embodiment of a recording apparatus according to the invention will be described hereinafter with reference to the drawings. It should be noted that in the drawings used in the following descriptions, an XYZ orthogonal coordinate system is employed, and the positional relationships of the various constituent elements will be described with reference to this XYZ orthogonal coordinate system. Here, a predetermined direction in the horizontal plane is taken as the X-axis direction (the width direction), the direction in the horizontal plane that is orthogonal to the X-axis direction is taken as the Y-axis direction (the transport direction), and the direction orthogonal to both the X-axis direction and the Y-axis direction (the vertical direction) is taken as the Z-axis direction.

In this embodiment, an ink jet printer (called simply a “printer” hereinafter) will be given as an example of a recording apparatus.

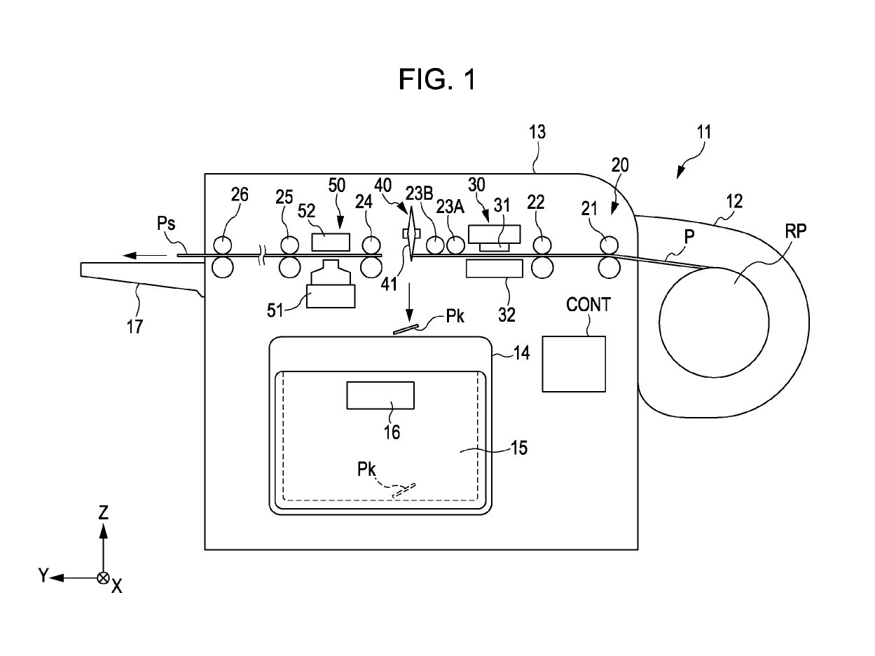

FIG. 1 is a general block diagram illustrating a printer 11 according to an embodiment of the invention.

The printer 11 is configured to print images, text, and the like by ejecting ink (a fluid) from a recording head 31 onto long paper (a recording medium) P let out from roll paper (a roll member) RP rolled up in roll form. The printer 11 includes: a transport unit (transport device) 20 that transports the paper P let out from the roll paper RP; a recording unit 30 that prints onto the paper P; a cutting unit 40 that cuts the paper P that has been printed onto to a predetermined size; a rear-surface printing unit 50 that prints onto the rear surface of the post-cutting paper Ps; and a control device CONT that carries out overall control of the operations performed by the stated constituent elements.

The printer 11 includes a case 12 that houses the roll paper RP and a main case unit 13 that houses the transport unit 20, the recording unit 30, the cutting unit 40, the rear-surface printing unit 50, and so on. A discharge tray 17, into which the paper Ps that has been printed onto and cut is discharged, is provided in the front side (that is, the +Y side) of the main case unit 13. A receptacle 15 that receives and collects cut pieces Pk produced when cutting the paper P (this will be called a “scrap receptacle 15” hereinafter) is disposed within a recess 14 formed, in the right side surface of the main case unit 13, so that the face thereof recedes slightly from the surface. The scrap receptacle 15 can, in this embodiment, be pulled out from the main case unit 13 in the direction orthogonal to the transport direction (the Y-axis direction) (that is, can be pulled out in the X-axis direction); the end surface thereof in that orthogonal direction is exposed in the recess 14, and a handle 16 for pulling out the scrap receptacle 15 is provided in that end surface.

Hereinafter, the various constituent elements provided in the printer 11 will be described, following the order in which the paper P is transported by a plurality of roller pairs functioning as the transport unit 20 provided in the printer 11. The transport unit 20 includes a supply roller pair 21, a transport roller pair 22, paper pressure rollers (regulating members) 23A and 23B, transport roller pairs 24 and 25, and a discharge roller pair 26. First, the paper P that has been let out from the roll paper RP is supplied to the recording unit 30 by the supply roller pair 21. The recording unit 30 includes the recording head 31 that ejects ink and a support platform 32 that supports the paper P.

In the recording unit 30, the paper P supplied from the roll paper RP is transported, and images or the like are printed onto the top (front) surface of the paper P. First, the paper P is fed between the recording head 31 and the support platform 32 by the transport roller pair 22. The top (front) surface of the paper P that has been fed is transported while maintaining a predetermined distance to the recording head 31, and at this time, printing is carried out by ejecting ink from the recording head 31 onto the top surface of the paper P. After this, the paper P is transported to the cutting unit 40 while being pressurized by the paper pressure rollers 23A and 23B.

The cutting unit 40 includes, as a functional component, a cutter 41 configured of a rotating blade or the like, and cuts the paper P into regions that accommodate the printed images or the like. At this time, the cutting unit 40 carries out the cutting so that unnecessary regions present at the ends of the printed region in the transport direction are eliminated. Accordingly, as shown in FIG. 1, cut pieces Pk are produced as a result of the paper P being cut, and the cut pieces Pk that are produced fall with the pull of gravity. Therefore, the scrap receptacle 15 is disposed below the cutting unit 40 in order to receive and hold the falling cut pieces Pk.

The paper Ps that has been cut is then transported to the rear-surface printing unit 50, where the rear surface of the paper P is printed upon. The rear-surface printing unit 50 includes a printing unit 51, which is of what is known as the “impact dot” type, that forms ink dots by pressurizing an ink ribbon against the bottom (rear) surface of the paper Ps, and a support platform 52 that supports the paper Ps from above when this printing is being carried out. In the rear-surface printing unit 50, the transported paper Ps is first fed between the printing unit 51 and the support platform 52 by the transport roller pair 24. Predetermined characters are then printed onto the paper Ps that has been fed, by the printing unit 51 recording dots onto the bottom (rear) surface thereof, and the paper Ps is then fed in the transport direction by the transport roller pair 25.

After this, the paper Ps is, for example, transported to a drying unit (not shown), and after undergoing a drying process performed by a heater unit (not shown) that is another functional component, is discharged to the discharge tray 17 by the discharge roller pair 26.

Next, the configuration of the recording unit 30 according to this embodiment will be described in detail.

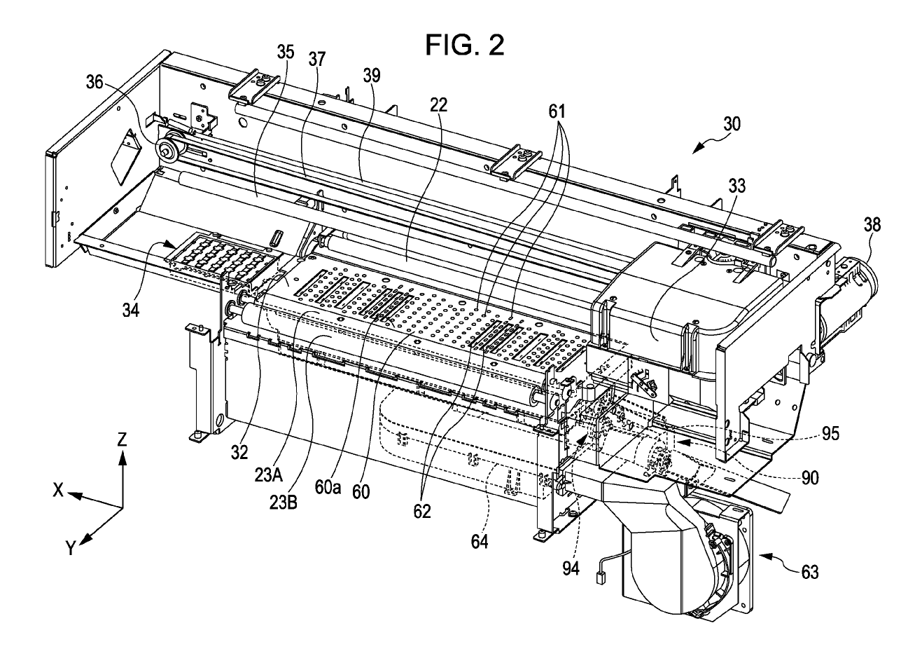

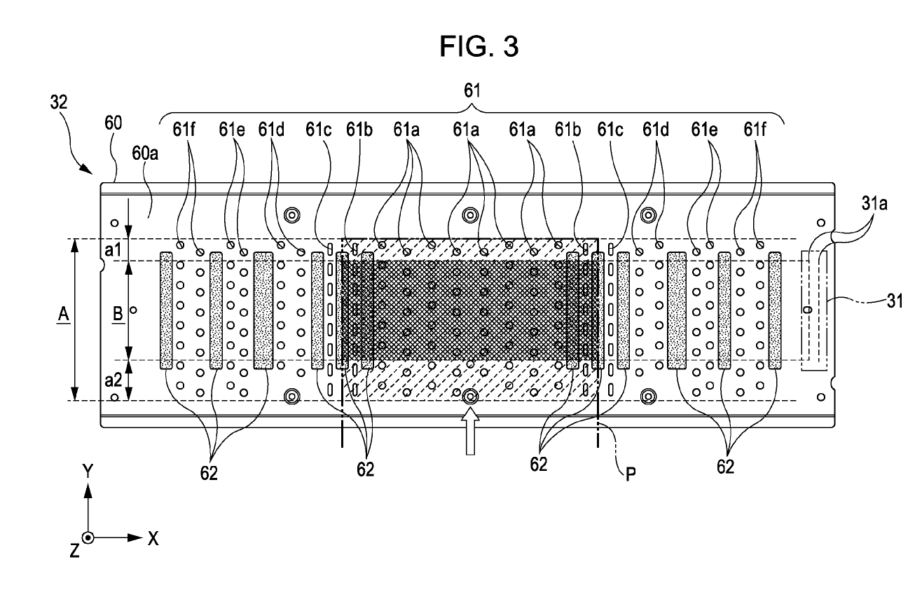

FIG. 2 is a perspective view of the recording unit 30 according to this embodiment of the invention. FIG. 3 is a plan view illustrating a platen 60 provided in the support platform 32 according to this embodiment of the invention.

Reference numeral 33 in FIG. 2 indicates a carriage in which the recording head 31 is mounted. The recording head 31 according to this embodiment is what is known as a serial-type ink jet head, mounted in the carriage 33, which moves in the width direction (the X-axis direction) of the transported paper P. Note that reference numeral 34 in FIG. 2 indicates a flushing box that carries out a maintenance process by flushing the recording head 31.

The carriage 33 is supported by a guide rod 35 so as to be capable of moving in the width direction. The configuration is such that the carriage 33 moves along the guide rod 35 as the result of a belt 37, which is stretched upon a pulley 36, being driven. The belt 37 is driven by a carriage motor 38. Furthermore, the recording unit 30 is provided with a linear encoder 39 that follows the movement path of the carriage 33. The linear encoder 39 detects the position of the carriage 33 in the width direction. The resulting detection signal is sent to the control device CONT as position information. The control device CONT recognizes the scanning position of the recording head 31 based on the position information from the linear encoder 39, and controls the printing operations and so on performed by the recording head 31.

The support platform 32 includes the platen (support member) 60, which in turn has a support surface 60a that supports the paper P. As shown in FIG. 2 and FIG. 3, a plurality of suction holes 61 for maintaining the levelness of the paper P are formed in the support surface 60a of the platen 60. In addition, a plurality of ink receiving portions 62 for receiving ink are provided in the platen 60 as openings in the support surface 60a; these ink receiving portions 62 are provided for the purpose of what is known as “borderless printing”. The ink receiving portions 62 are provided with ink absorption members such as, for example, sponges, nonwoven fabrics, or the like that absorb ink. The supply method for the paper P in this embodiment employs what is known as “centered supply”, and the ink receiving portions 62 are disposed symmetrically relative to the location of the center of the platen 60. The ink receiving portions 62 are provided in each of positions corresponding to paper widths based on standards for the paper P (A4, B4, A3, B3, and so on).

A suction region A, in which the plurality of suction holes 61 apply suction to the paper P, extends in the width direction (the X-axis direction). The configuration is such that a fan 63, shown in FIG. 2, generates the suction through the suction holes 61. The fan 63 and the base area of the support platform 32 are connected via a duct 64. The recording unit 30 according to this embodiment includes a suction stopping device 90 that stops the suction of the suction holes 61 in the suction region A that are located outside the paper P in the width direction, in order to suppress the flight of the ink from curving during printing.

Next, the configuration of the support platform 32, including the suction stopping device 90, according to this embodiment will be described in detail.

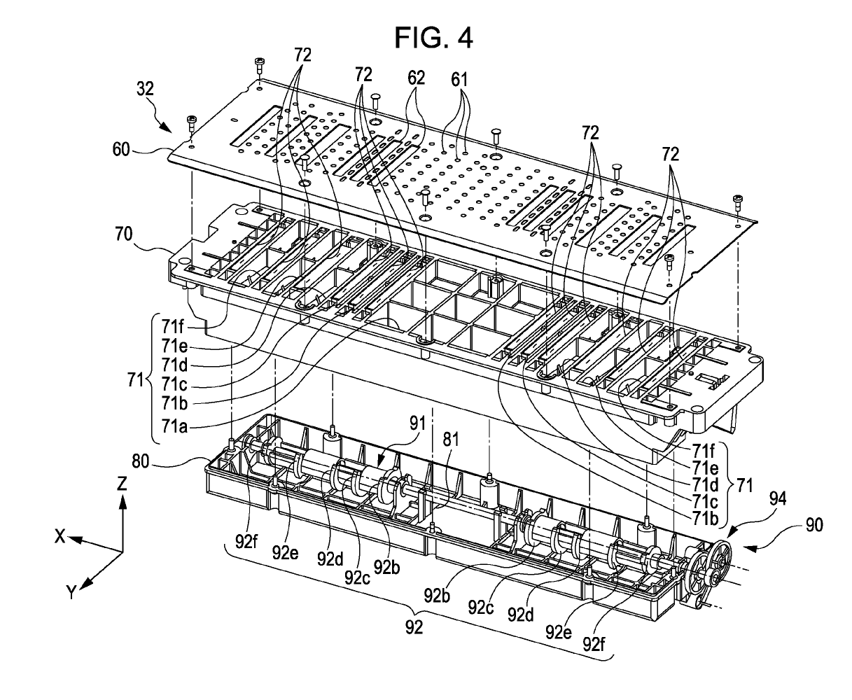

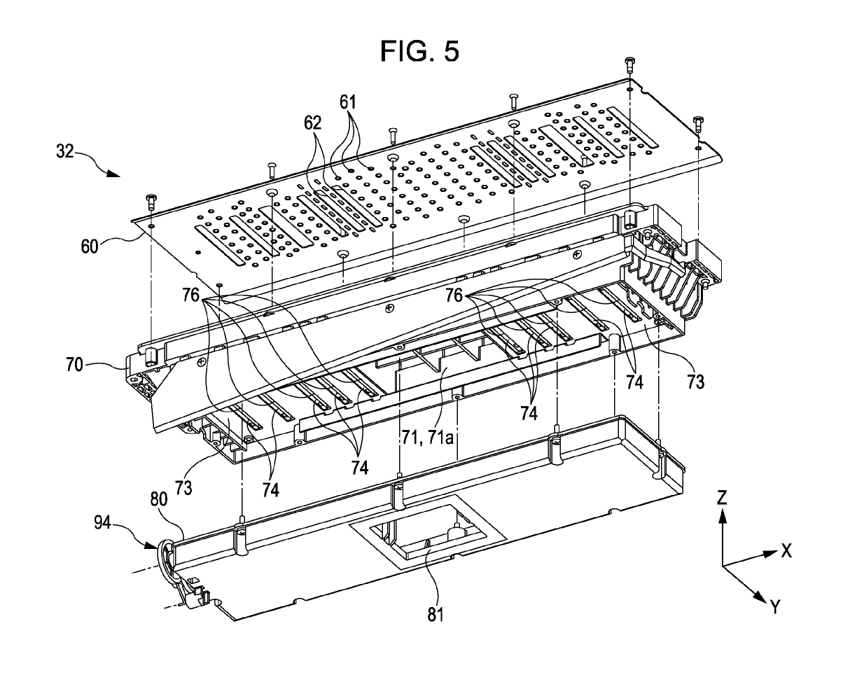

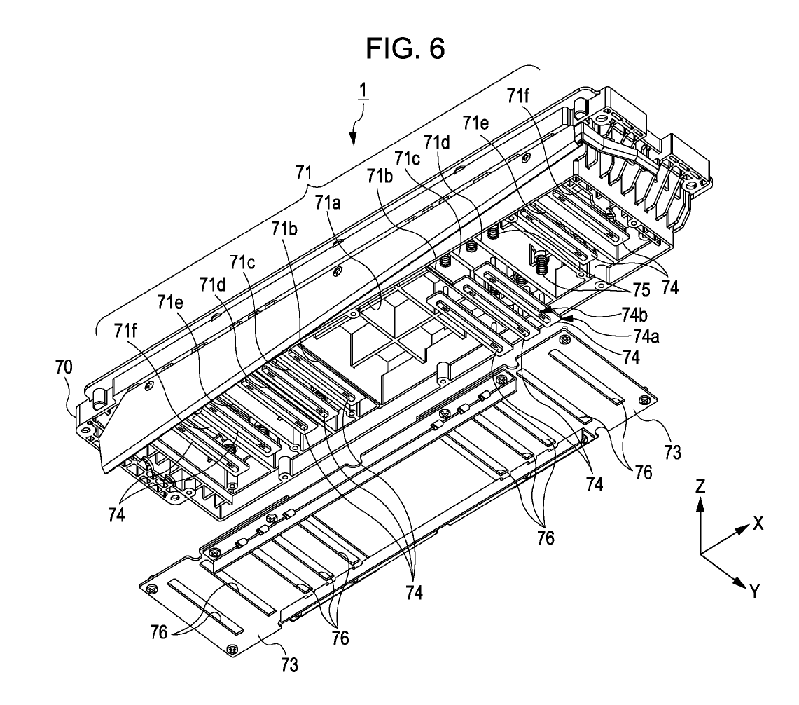

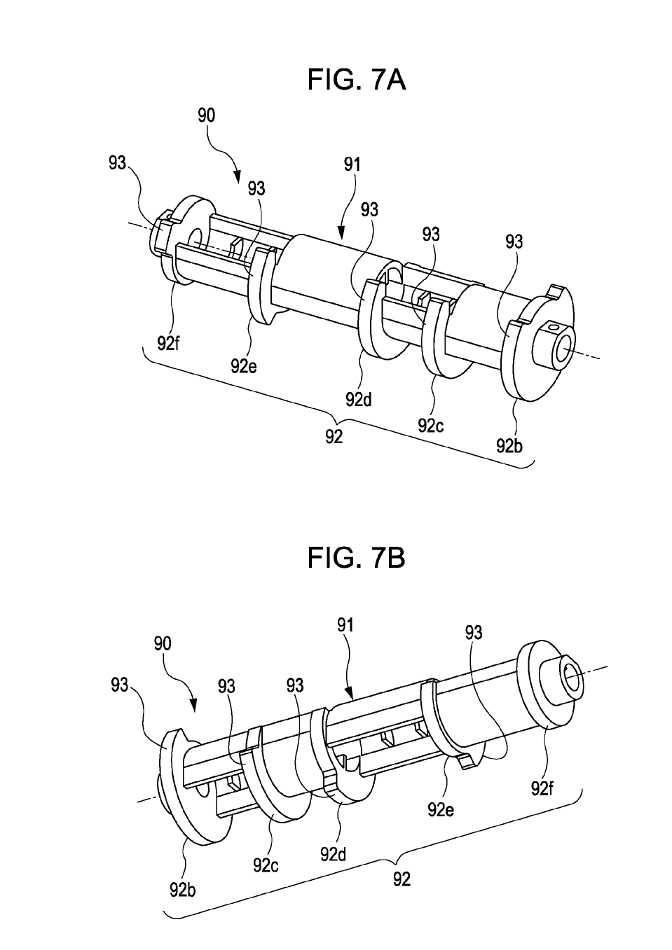

FIG. 4 is an exploded perspective view illustrating the support platform 32 according to this embodiment of the invention. FIG. 5 is another exploded perspective view illustrating the support platform 32 according to this embodiment of the invention. FIG. 6 is an exploded perspective view illustrating a main support platform unit 70 according to this embodiment of the invention. FIGS. 7A and 7B are perspective views of a cam mechanism 91 in the suction stopping device 90 according to this embodiment of the invention.

As shown in FIG. 4, the support platform 32 is configured by combining the platen 60, the main support platform unit 70, and a base frame 80. Air chambers 71 that communicate with the suction holes 61 and ink receiving chambers 72 that communicate with the ink receiving portions 62 are formed in the main support platform unit 70. The air chambers 71 are divided in multiple based on their positions in the width direction. To be more specific, the air chambers 71 are divided in each region that is surrounded by ink receiving chambers 72. Note that the central air chamber 71 is referred to as an air chamber 71a, the air chamber 71 that is adjacent to the air chamber 71a on the outside thereof is referred to as an air chamber 71b, the air chamber 71 that is adjacent to the air chamber 71b on the outside thereof is referred to as an air chamber 71c, the air chamber 71 that is adjacent to the air chamber 71c on the outside thereof is referred to as an air chamber 71d, the air chamber 71 that is adjacent to the air chamber 71d on the outside thereof is referred to as an air chamber 71e, and the air chamber 71 that is adjacent to the air chamber 71e on the outside thereof is referred to as an air chamber 71f.

As shown in FIG. 5, the bases of the air chambers 71 aside from the air chamber 71a are closed off by a frame 73 and valve members 74. In other words, the air chamber 71a is provided in a region that corresponds to the minimum width of the paper P, and is therefore always open; the suction holes 61 that communicate with this air chamber 71a therefore carry out suction regardless of the width of the paper P.

As shown in FIG. 6, the valve members 74 are provided in each of the air chambers 71 aside from the air chamber 71a. The valve members 74 are biased downward by a biasing member 75. Each of the valve members 74 includes a rectangular-shaped base portion 74a that extends in the transport direction and a projecting portion 74b that projects downward from the base portion 74a. The projecting portion 74b is of a size that enables the projecting portion 74b to be inserted into a corresponding opening portion 76 formed in the frame 73.

Returning to FIG. 4, the base frame 80 is configured so as to be connected to the base of the main support platform unit 70 and to function as a chamber. An opening portion 81, to which the duct 64 (see FIG. 2) is connected, is provided in the central area of the base frame 80. The cam mechanism 91, which selectively raises the valve members 74, is provided in this base frame 80. The cam mechanism 91 is configured so as to include cams 92, of shapes that correspond to respective valve members 74, in positions that correspond to the respective valve members 74, and the cams 92 are supported so as to be freely-rotatable around a shaft that extends in the width direction. Specifically, the cam mechanism 91 includes a cam 92b that corresponds to the valve member 74 of the air chamber 71b, a cam 92c that corresponds to the valve member 74 of the air chamber 71c, a cam 92d that corresponds to the valve member 74 of the air chamber 71d, a cam 92e that corresponds to the valve member 74 of the air chamber 71e, and a cam 92f that corresponds to the valve member 74 of the air chamber 71f.

As shown in FIG. 7A and FIG. 7B, the cams 92 have shapes that differ depending on their positions in the width direction. The cams 92 include projections 93 having radii that enable those projections 93 to come into contact with the projecting portions 74b of the corresponding valve members 74, and the percentage of space in the circumferential direction that is occupied by these projections 93 differs among the cams 92b to 92f. This percentage is greatest for the projection 93 of the cam 92b, and decreases in order from the cam 92c to the cam 92f.

Specifically, by rotating the cam mechanism 91 central to the shaft, it is possible to switch among the states described hereinafter: a state in which none of the cams 92b to 92f are in contact with their corresponding valve members 74; a state in which only the cam 92b raises its corresponding valve member 74 and opens the air chamber 71b; a state in which the cams 92b and 92c raise their corresponding valve members 74 and open the air chambers 71b and 71c; a state in which the cams 92b to 92d raise their corresponding valve members 74 and open the air chambers 71b to 71d; a state in which the cams 92b to 92e raise their corresponding valve members 74 and open the air chambers 71b to 71e; and a state in which all of the cams 92b to 92f raise their corresponding valve members 74 and open all of the air chambers 71b to 71f.

The cam mechanism 91 configured as described above is configured so as to be rotationally driven by a motor 95 (see FIG. 2) that is connected via a gear mechanism 94. The configuration is furthermore such that the control device CONT drives the motor 95 based on paper width information of the paper P that has been set, and controls the rotational angle of the cam mechanism 91. Specifically, in the case where paper P of the width illustrated in FIG. 3 has been set, the cam mechanism 91 is driven so that only the cam 92b raises its corresponding valve member 74 and opens the air chamber 71b. By doing so, it is possible to stop the suction of the suction holes 61c through 61f in the suction region A that is distanced from the paper P in the width direction. Note that, in FIG. 3, the suction holes 61a communicate with the air chamber 71a, the suction holes 61b communicate with the air chamber 71b, the suction holes 61c communicate with the air chamber 71c, the suction holes 61d communicate with the air chamber 71d, the suction holes 61e communicate with the air chamber 71e, and the suction holes 61f communicate with the air chamber 71f.

As shown in FIG. 3, the plurality of suction holes 61 form a plurality of rows that follow the transport direction (the Y-axis direction) and have intervals therebetween in the width direction (the X-axis direction). The plurality of suction holes 61 are disposed in the same shape and at the same pitch in the respective rows that follow the transport direction. This plurality of rows includes a first row having suction holes 61 of a first shape (a round shape) and a second row having suction holes 61 of a second shape (a long-hole shape). The first row includes rows of the suction holes 61a and 61d to 61f. The second row, meanwhile, includes rows of the suction holes 61b and 61c. Ink receiving portions 62 are provided on both sides of the second row in the width direction. The suction holes 61b and 61c in the second row have long-hole shapes that extend in the transport direction. As a result, the suction holes 61b and 61c in the second row can be disposed in the narrow region in which the ink receiving portions 62 are provided and thus a degree of width cannot be secured, and can apply suction to the paper P.

The suction region A, in which the plurality of suction holes 61 apply suction to the paper P, includes, in the transport direction, a printing region B in which the recording head 31 carries out printing, and extends to the upstream side and the downstream side of the printing region B. The configuration is such that a length a1 of the suction region A on the downstream side in the transport direction is smaller than a length a2 of the suction region A on the upstream side.

Note that the “length of the suction region A in the transport direction” refers to the length, along the support surface 60a, from the suction holes 61 provided furthest upstream in the transport direction (the Y-axis direction) to the suction holes 61 provided furthest downstream in the transport direction. Furthermore, the “length of the printing region B in the transport direction” refers to the length from the upstream end (upper end) of a nozzle row 31a of the recording head 31, which ejects ink, in the transport direction (the Y-axis direction), to the downstream end (lower end) of the nozzle row 31a in the transport direction.

Because the paper P is extended and fed out from the roll paper RP, the influence of curls at the leading edge thereof is great. Furthermore, although lift-off of the leading edge of the paper P is reduced by increasing the suction power, it is difficult to completely hold the paper P on the support surface 60a. Accordingly, in this embodiment, the configuration is such that the suction region A is extended to the downstream side of the printing region B in the transport direction, thus removing, from the printing region B, the area at which the leading edge of the paper P lifts off. However, the leading edge of the paper P that extends outside of the printing region B is an area that is treated as an unnecessary region and is therefore cut off by the cutting unit 40 as a cut piece Pk, and therefore the length a1 of the suction region A on the downstream side is set to a minimum length based on the curling properties of the leading edge of the paper P, which will be mentioned later. Accordingly, the configuration is such that the length a1 of the suction region A on the downstream side in the transport direction is smaller than a length a2 of the suction region A on the upstream side.

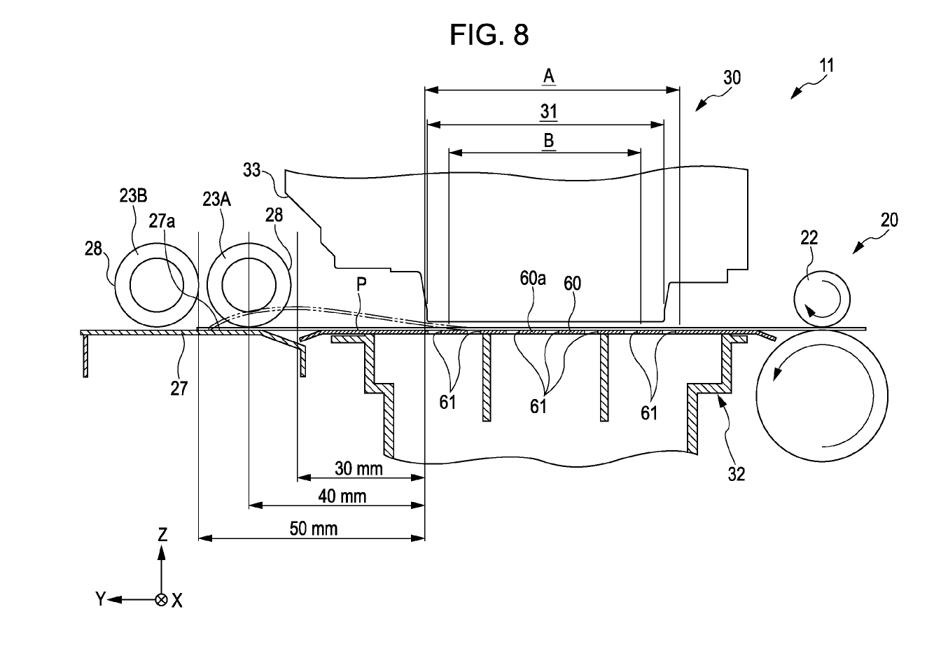

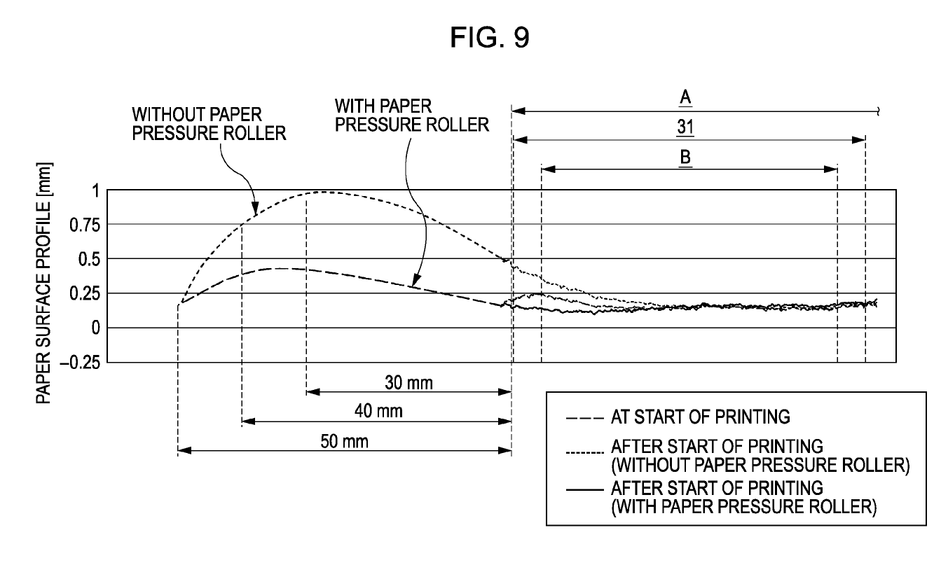

Continuing on, the configuration and layout of the paper pressure rollers 23A and 23B will be described with reference to FIG. 8 and FIG. 9.

FIG. 8 is a diagram illustrating the layout of the paper pressure rollers 23A and 23B according to this embodiment of the invention. FIG. 9 is a graph illustrating degrees to which the leading edge of the paper P lifts off from the support surface 60a, according to this embodiment of the invention. Note that FIG. 9 shows a profile of the surface height of the paper P under conditions in which the suction pressure in the suction region A is 350 Pa, the ambient air is at 32° C., and the humidity is at 20%.

As shown in FIG. 8, the paper pressure roller 23A is provided downstream from the suction holes 61 that are formed in the location that is furthest downstream in the transport direction (the Y-axis direction) (that is, the downstream end of the suction region A), and is configured so as to suppress the paper P from lifting off from the support surface 60a by more than a predetermined height. The paper pressure roller 23A is disposed opposite to a paper support plate 27. The paper support plate 27 has a support surface 27a that is approximately the same height as, and is essentially linked continuously with, the support surface 60a of the platen 60. On the other hand, the paper pressure roller 23B is provided further downstream from the paper pressure roller 23A in the transport direction, and is configured so as to apply pressure to the paper P against the support surface 27a in order to ensure that the cutting by the cutting unit 40 (see FIG. 1) provided downstream therefrom is carried out properly.

The paper pressure rollers 23A and 23B are supported so as to be freely rotatable around shafts extending in the width direction (the X-axis direction). According to this configuration, the paper pressure rollers 23A and 23B can prevent the occurrence of abrasions and the like on the paper P by converting friction generated with the paper P into their own rotational movement.

Meanwhile, the circumferential surfaces (contact portions) 28 of the paper pressure rollers 23A and 23B make contact with the upper (top) surface of the printed paper P, and are therefore configured of a material selected having taken into consideration the effects of that material on the print quality (so as to avoid, for example, damaging the paper, disturbing the printed surface with ink that has adhered to the rollers, or soiling the paper). It is preferable to employ, as the circumferential surfaces of the paper pressure rollers 23A and 23B in this embodiment, a urethane foam (for example, ENDUR, manufactured by INOAC) having a hardness (Asker hardness) of approximately 20.

The paper pressure rollers 23A and 23B are provided so that the circumferential surfaces 28 thereof are distanced from the paper support plate 27 by a predetermined amount of space. To be more specific, the circumferential surfaces 28 are distanced from the support surface 27a in the vertical direction relative to the support surface 27a (that is, the Z-axis direction) by an amount of space that is greater than or equal to the thickness of the paper P, so that the leading edge of the paper P can be brought into that space. In this embodiment, the space between the circumferential surfaces 28 and the support surface 27a is approximately 0.5 to 1.0 mm.

The location of the paper pressure roller 23A in the transport direction (the Y-axis direction) is set based on the curling properties of the paper P. In other words, because the amount by which the paper P lifts off is dependent on the curling properties of the paper P (that is, the strength of the curl, the material, the humidity, and so on) as shown in FIG. 9, the position of the paper pressure roller 23A in the transport direction is set taking those curling properties into consideration. Specifically, the position of the paper pressure roller 23A in the transport direction is set to a position in which the lift-off of the paper P caused by the curl of the paper P does not extend into the suction region A and in which the apex of the curve resulting from the lift-off does not reach the recording head 31. To be more specific, in this embodiment, the paper pressure roller 23A is disposed approximately 40 mm from the downstream end of the suction region A in the transport direction, based on the curling properties of the paper P.

Next, printing operations carried out by the recording unit 30 of the printer 11 configured as described above will be described.

First, based on the width of the paper P that has been set, suction performed by the suction holes 61 in the suction region A that fall outside of the paper P in the width direction is stopped. Specifically, this is carried out by the control device CONT driving the suction stopping device 90. In the case where paper P of the width illustrated in FIG. 3 has been set, the control device CONT controls the rotational angle of a cam mechanism 91 by driving the motor 95 based on the paper width information of the paper P that has been set, resulting in a state in which only the cam 92b raises its corresponding valve member 74 and the air chamber 71b is open. Then, the fan 63 is driven, so that suction is applied through the suction holes 61a that communicate with the air chamber 71a that is always open and the suction holes 61b that communicate with the air chamber 71b that has been opened. On the other hand, the air chambers 71c to 71f remain closed by their corresponding valve members 74, and thus the suction by the suction holes 61c to 61f in the suction region A that is outside of the paper P in the width direction can be stopped.

Next, the paper P is transported in the Y-axis direction along the support surface 60a of the platen 60 by the transport unit 20. When the leading edge of the paper P advances into the suction region A, the suction force from the suction holes 61a and 61b acts thereon. In the suction region A, the suction holes 61a and 61b are formed in the same shape and at the same pitch in the respective rows that follow the transport direction, and therefore the suction force that acts as the paper P is transported is held constant, and fluctuations therein can be suppressed. Accordingly, the precision with which the paper P is transported can be increased.

Furthermore, because the shape of the suction holes 61b that are surrounded by the ink receiving portions 62 is a long-hole shape that extends in the transport direction, suction can be applied to the paper P even in narrow regions in which a degree of width cannot be secured.

Furthermore, upon detecting, based on a paper feed amount, by sensors (not shown), and so on, that the leading edge of the paper P in the transport direction has passed the printing region B and has reached a position that covers the suction holes 61 formed in the location of the support surface 60a that is furthest downstream in the transport direction, the control device CONT causes the recording head 31 to execute printing. In this embodiment, the suction region A extends further downstream in the transport direction than the printing region B, and thus the portion of the leading edge of the paper P that lifts off can be placed outside of the printing region B. In addition, at this time, all of the suction holes 61a and 61b are blocked by the paper P, and thus no unnecessary airflow is generated in the periphery of the paper P. Accordingly, the recording head 31 can print onto the paper P, whose levelness is maintained, without causing the flight of the ink to curve. As a result, it is possible to form high-quality images and so on on the surface of the paper P.

The printing is commenced at the location where the leading edge of the paper P has reached the downstream end of the suction region A, and thereafter, the paper P is fed downstream in the transport direction by a predetermined paper feed amount.

Here, as shown in FIG. 9, at the point in time when the printing is commenced, the leading edge of the paper P lifts off slightly due to curling. In this embodiment, this lift-off is approximately 0.1 mm (approximately 0.2 mm at an involute region (that is, the region near the core) of the roll paper RP, where the curls are stronger); with this degree of lift-off, no contact is made with the recording head 31, there is no effect on the print quality, and thus this lift off is not particularly problematic.

However, if the paper P is transported further downstream in the transport direction, the leading edge thereof advances into the region in which the suction region A is not present, and thus the lift-off of the paper P increases gradually; as a result, the paper P lifts off in the printing region B as well. The line indicated as “after start of printing” and “without paper pressure roller” in FIG. 9 indicates a limit value where no contact will be made with the recording head 31 and there is no effect on the print quality. The result of evaluations indicates that the position where the leading edge of the paper P has reached a position that is approximately 50 mm from the downstream end of the suction region A in the transport direction is the limit, and that the paper P will lift off more if the paper P is transported further than this limit, resulting in negative effects on the print quality (that is, the paper P will come into contact with the recording head 31; the lift-off of the leading edge will affect lift off of portions of the paper P in the printing region B, causing some of the suction holes 61 to be exposed, thus pulling ink to the rear of the paper P; and so on).

Accordingly, in this embodiment, the paper pressure roller 23A is provided in order to suppress the paper P from lifting off in this manner. It was determined, as a result of evaluations, that it is most effective to dispose the paper pressure roller 23A in the vicinity of the apex of the surface profile of the paper P (in FIG. 9, approximately 30 mm from the downstream end of the suction region A). Although in this embodiment, the paper pressure roller 23A is disposed 40 mm from the downstream end of the suction region A in order to avoid interference with other constituent elements, it can be seen from the line indicated as “after start of printing” and “with paper pressure roller” in FIG. 9 that contact with the recording head 31 and lift-off of the paper P in the printing region B is successfully avoided.

Accordingly, according to the aforementioned embodiment, the recording head 31 can be caused to carry out printing in a state in which all of the suction holes 61 are blocked and no unnecessary airflow is generated in the periphery of the paper P, and the leading edge of the paper P can be suppressed from lifting off as the paper P gradually moves away from the suction region A due to the transport during printing, by employing the printer 11 that includes: the platen 60 in which a plurality of suction holes 61 that apply suction to the paper P are formed in the support surface 60a that supports the paper P; the transport unit 20 that transports the paper P along the support surface 60a; the recording head 31 that prints onto the paper P supported by the support surface 60a by ejecting ink; the control device CONT that causes the recording head 31 to execute the printing when the leading edge of the paper P in the transport direction has reached a position where the leading edge covers the suction holes 61 formed in the location of the support surface 60a that is furthest downstream in the transport direction; and the paper pressure roller 23A, provided downstream from the suction holes 61 formed in the location of the support surface 60a that is furthest downstream in the transport direction, that suppresses the paper P from lifting off the support surface 60a by more than a predetermined height.

Accordingly, according to this embodiment, it is possible to suppress a drop in the print quality caused by the ink experiencing curved flight while ensuring the levelness of the paper P.

Although an exemplary embodiment of the invention has been described thus far with reference to the drawings, the invention is not intended to be limited to the aforementioned embodiment. The forms, combinations, and so on of the various constituent elements illustrated in the aforementioned embodiment are merely exemplary, and many variations based on design requirements and the like are possible without departing from the essential spirit of the invention.

For example, although the aforementioned embodiment describes an example in which a regulating member is the paper pressure roller 23A configured of a urethane foam, the regulating member may be a star-shaped roller (a knurled roller), a guide plate, or the like.

In addition, the support surface (second support surface) 27a that opposes the paper pressure roller 23A and supports the paper P may be provided further from the recording head 31 in the Z-axis direction than the support surface 60a. According to this configuration, even if the leading edge of the paper P lifts off, that lift-off can be pushed away from the recording head 31 (that is, in the −Z direction), which makes it possible to prevent, with certainty, the leading edge of the paper P from coming into contact with the recording head 31.

Furthermore, if the printer 11 is a dedicated device that prints onto paper P of a set width, the configuration may be such that the width of the suction region A is set based on that paper width. In other words, even without the suction stopping device 90, the same effects as in the aforementioned embodiment can be achieved if the control device CONT causes the recording head 31 to execute printing when the leading edge of the paper P in the transport direction has reached a position that covers the suction holes 61 that are in the location of the support surface 60a that is furthest downstream in the transport direction.

In addition, although the aforementioned embodiment describes an example in which the recording apparatus is the printer 11, the recording apparatus is not limited to a printer, and may instead be a device such as a copier, a facsimile machine, or the like.

Furthermore, a recording apparatus that ejects and discharges a fluid aside from ink may be employed as the recording apparatus. The invention can be applied, for example, in various types of recording apparatuses provided with recording heads that eject extremely small-volume liquid droplets. Note that “droplet” refers to the state of the liquid ejected from the recording apparatus, and is intended to include granule forms, teardrop forms, and forms that pull tails in a string-like form therebehind. Furthermore, the “liquid” referred to here can be any material capable of being ejected by the recording apparatus. For example, any matter can be used as long as the matter is in its liquid state, including liquids having high or low viscosity, sol, gel water, other inorganic agents, organic agents, liquid solutions, liquid resins, and fluid states such as liquid metals (metallic melts); furthermore, in addition to liquids as a single state of a matter, liquids in which the molecules of a functional material composed of a solid matter such as pigments, metal particles, or the like are dissolved, dispersed, or mixed in a liquid carrier are included as well. Ink, described in the above embodiment as a representative example of a liquid, can be given as an example. Here, “ink” generally includes water-based and oil-based inks, as well as various types of liquid compositions, including gel inks, hot-melt inks, and so on. Furthermore, the specific example of the recording apparatus is not limited to an apparatus in which a roll of paper, in which paper is wound up in roll form, is provided within a housing member (the case 12), as described in the aforementioned embodiment. For example, any device can be employed as the recording apparatus as long as that device includes a long recording medium, such as a flexible substrate or metallic plate, plastic sheets, cloth, or the like, wound up in roll form and provided within a housing member. Furthermore, the long recording medium provided in the housing member does not necessarily need to be wound up in roll form, and may, for example, be folded in an accordion-like shape.

What is claimed is:

1. A recording apparatus comprising:
a support member in which a plurality of suction holes that apply suction to a recording medium are formed in a support surface that supports the recording medium;
a transport device that transports the recording medium along the support surface;
a recording head that prints onto the recording medium supported by the support surface by ejecting a fluid;
a control device that causes the recording head to execute the printing when the leading edge of the recording medium in the transport direction has reached a position where the leading edge covers the suction holes formed in the location of the support surface that is furthest downstream in the transport direction; and
a regulating member, provided downstream from the suction holes formed in the location of the support surface that is furthest downstream in the transport direction, that suppresses the recording medium from lifting off the support surface by more than a predetermined height.

2. The recording apparatus according to claim 1,
wherein a suction region in which the plurality of suction holes apply suction to the recording medium includes, in the transport direction, a printing region in which printing is carried out by the recording head, and extends further upstream and further downstream than the printing region; and
the length of the suction region on the downstream side in the transport direction is less than the length of the suction region on the upstream side.

3. The recording apparatus according to claim 1, wherein a contact portion of the regulating member that makes contact with the recording medium and suppresses the recording medium from lifting off is provided at a distance from the support surface, in the vertical direction relative to the support surface, that is greater than or equal to the thickness of the recording medium.

4. The recording apparatus according to claim 1, wherein a contact portion of the regulating member that makes contact with the recording medium and suppresses the recording medium from lifting off is the circumferential surface of a roller supported so as to be freely-rotatable around a shaft extending in the width direction of the recording medium, the width direction being orthogonal to the transport direction.

5. The recording apparatus according to claim 1, wherein the recording medium extends and is transported from a roll member.

6. The recording apparatus according to claim 1, wherein the location of the regulating member in the transport direction is set based on curling properties of the recording medium.

7. The recording apparatus according to claim 1, further comprising:
a second support surface that opposes the regulating member and supports the recording medium,
wherein the second support surface is provided further from the recording head, in the vertical direction relative to the support surface, than the support surface.

8. The recording apparatus according to claim 1,
wherein a suction region in which the plurality of suction holes apply suction to the recording medium extends in the width direction of the recording medium, the width direction being orthogonal to the transport direction; and
the recording apparatus further comprises:
a suction stopping device that stops the suction applied by the suction hole in the areas of the suction region that are outside of the recording medium in the width direction.
